(19) United States
(12) Patent Application Publication
(10) Pub. No.: US 2024/0409183 A1
(43) Pub. Date: Dec. 12, 2024

(54) AXLE RETENTION FOR AN ELECTRIC BICYCLE

(71) Applicant: Rad Power Bikes Inc., Seattle, WA (US)

(72) Inventors: Bryan Ford, Seattle, WA (US); Mari Alicia Murai, Everett, WA (US); Blair Ellington, Redmond, WA (US); Redwood Stephens, Seattle, WA (US)

(21) Appl. No.: 18/736,364

(22) Filed: Jun. 6, 2024

Related U.S. Application Data
(60) Provisional application No. 63/506,432, filed on Jun. 6, 2023.

(51) Int. Cl. B62M 6/65; B60L 7/10

(52) U.S. Cl. CPC B62M 6/65; B60L 7/10; B60L 2200/12

(57) ABSTRACT

An electric bicycle includes a frame, a battery, and a motor coupled to the battery, the motor comprising a stator, a rotor configured to rotate around the stator, a motor casing enclosing the stator and the rotor, an axle coupled to the stator, the axle comprising a first exposed portion that extends out of a non-drive side of the motor casing and a second exposed portion that extends out of a drive side of the motor casing, and a torque plate rigidly affixed to the first exposed portion of the axle, the torque plate having a planar configuration aligned with a plane that is perpendicular to a central axis of the axle.

### CROSS REFERENCE TO RELATED APPLICATIONS

This application claims priority to and benefits of U.S. Provisional Patent Application No. 63/506,432, filed Jun. 6, 2023, which is incorporated by reference in its entirety.

### OVERVIEW

Electric bicycles, or e-bikes, are a popular method of transportation for use by individual riders, families, commercial enterprises and fleets, and so on. Unlike traditional bikes, an e-bike provides assisted modes of travel to a rider, including a pedal assist mode that utilizes power from a motor to assist the rider in pedaling and/or a throttle mode where the motor, when engaged, powers the e-bike without any pedaling from the rider.

Electric bicycles are powered by electric batteries, such as one or more battery packs of multiple battery cells. Conventional battery packs align the cells in series and/or parallel, often positioned right next to one another within a chassis of the battery pack. Typically, the battery pack is mounted externally to a frame component of a bicycle, and/or integrated into the frame of a bicycle.

### SUMMARY

Embodiments of the present disclosure are directed to a motor for an electric vehicle comprising a torque plate, and an electric bicycle including a motor with a torque plate.

In an embodiment, an electric motor for an electric vehicle comprises a stator, a rotor configured to rotate around the stator, a casing enclosing the stator and the rotor, an axle coupled to the stator, the axle comprising a first exposed portion that extends out of a non-drive side of the casing and a second exposed portion that extends out of a drive side of the casing, and a torque plate rigidly affixed to the first exposed portion of the axle, the torque plate having a planar configuration aligned with a plane that is perpendicular to a central axis of the axle.

The axle may include a flat surface on the first exposed portion, and the torque plate comprises an opening with a flat surface in contact with the flat surface of the axle.

In an embodiment, the electric motor includes a second torque plate removably coupled to the second exposed portion of the axle.

The axle may include a cable opening that leads to a cable path inside the axle, and the torque plate may include a slot that provides a route to the cable opening in the axle.

The torque plate may be rigidly affixed to the axle by at least one of a press fit, a weld, and an adhesive bond.

The axle may have a first thickness, a second thickness that is less than the first thickness, and a shoulder between the first thickness and the second thickness, and the torque plate may be pressed against the shoulder between the first and the second thickness. The axle may have a third thickness adjacent to the second thickness and less than the second thickness, and a portion of the torque plate may extend over the third thickness of the axle.

The torque plate may have an asymmetric shape, and a through hole configured to engage with a vehicle frame may be located in a lobe of the asymmetric shape.

The torque plate may have a thickness within a range of about 3 to 10 mm, a width within a range of about 10 to 40 mm, and a height within a range of about 25 to 60 mm.

In an embodiment, an electric bicycle includes a frame, a battery, and a motor coupled to the battery, the motor comprising a stator, a rotor configured to rotate around the stator, a casing enclosing the stator and the rotor, an axle coupled to the stator, the axle comprising a first exposed portion that extends out of a non-drive side of the casing and a second exposed portion that extends out of a drive side of the casing, and a torque plate rigidly affixed to the first exposed portion of the axle, the torque plate having a planar configuration aligned with a plane that is perpendicular to a central axis of the axle.

### BRIEF DESCRIPTION OF THE DRAWINGS

Embodiments of the present technology will be described and explained through the use of the accompanying drawings.

FIG. 1 is a diagram illustrating an electric bicycle.

FIG. 2 is a diagram illustrating a motor for an electric bicycle.

FIG. 3 is a diagram illustrating a motor axle mounted to a frame.

FIG. 4 is a diagram illustrating a torque plate fixed to an axle of an electric bicycle.

FIG. 5 is a diagram illustrating cable routing aspects of a motor assembly.

In the drawings, some components are not drawn to scale, and some components can be combined for discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

An electric bicycle that utilizes a hub, rear, or direct drive motor can implement regenerative braking, or regen, of a battery pack. For example, when a rider applies the brakes of the electric bicycle, the electric battery is recharged, because the motor turns into a generator and returns energy into the battery (instead of drawing energy from the battery when powering the bicycle). Thus, regen operates to recharge a battery when the hub motor is controlled to act as a generator during braking of the electric bicycle.

When the motor acts as a generator during regen, an applied torque (or resistive torque) can cause various components of the motor that fix the motor to a rear axle to loosen or otherwise move, causing drawbacks associated with operation and safety of the electric bicycle. Torque can be especially problematic in rapid transitions between drive and regenerative braking modes of a motor. The technology described herein provides an enhanced design, where a torque plate is rigidly fixed (e.g., semi-permanently) to the rear axle, enabling the torque plate to properly transfer axle torque (e.g., torque applied during regen) to a frame of the electric bicycle.

Unlike previous designs, where the hardware does not provide a “contact fit” between an axle and a torque plate (causing other components, such as M12 flange nuts, to receive the applied torque and loosen or otherwise degrade), having a torque plate fixed to the axle can effectively transfer torque from the axle to the frame, which can better withstand the applied forces, among other benefits. When torque is transferred from the axle to the frame by a torque plate as described herein, the axle leverages rigidity from the frame to resist tortional forces (torque), reducing the amount of twist the axle would otherwise experience. Accordingly, a torque plate may enhance the tortional stiffness of the axle, thereby increasing the smoothness of the ride of an electric bicycle and improving reliability.

In more detail, previous designs comprise motors with axles which are clamped to dropouts of a frame using mechanical components such as flange nuts which are engaged with a threaded portion of the axle, creating a clamping force that clamps the dropout between the axle and the nut. While this clamping force is generally adequate to hold the axle in place with respect to the frame, the interface between the axle and the dropouts is minimally effective in transferring tortional force from the axle to the dropouts, and therefore minimally effective in limiting the ability of the axle to twist. One reason that limits previous designs from transferring torque from the axle to the dropouts is that the interface between the axle and a dropout, as well as the interface between the nut and the dropout, is parallel to the direction of tortional forces at the axle (perpendicular to a central axis of the axle). This configuration allows the axle to slide against the planar interface with the dropout when high levels of torque are experienced by the axle.

While the various technologies are described with respect to, or for use by, an electric bicycle, the technologies can be configured or utilized with other bicycles or cycles, electric scooters or other wheeled micro-mobility vehicles, mopeds, other electric vehicles, other apparatus or devices that utilize motors for regenerative braking, and so on. Technologies may be applied to a wheeled electric vehicle with or without regenerative braking.

Various embodiments of the technology will now be described. The following description provides specific details for a thorough understanding and an enabling description of these embodiments. One skilled in the art will understand, however, that these embodiments may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments.

### Examples of Axle Retention for an Electric Bicycle

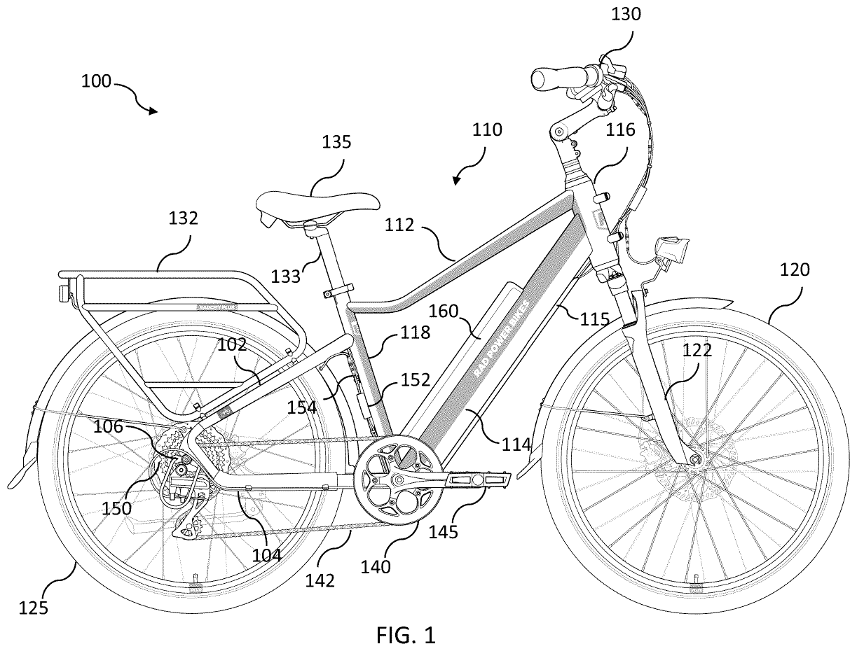

FIG. 1 depicts an electric bicycle 100 that can incorporate the technology described herein. The electric bicycle 100, as depicted, has a high-step frame geometry, such as a frame 110 with a top tube 112 that forms a front triangle with a down tube 114 and a seat tube 118.

The electric bicycle 100 further includes a head tube 116 that incorporates a front fork 122 and handlebars 130. The top tube 112 connects the head tube 116 to the seat tube 118, which may be substantially parallel to the head tube 116. The down tube 114 also connects the head tube 116 to the seat tube 118 at a bottom portion of the seat tube 118 at a bottom bracket. A seat post 133 is positioned partially in the seat tube 118 and extends or protrudes outwardly from the seat tube 118. The seat post 133 supports a seat 135 (or saddle), upon which a rider sits on the bicycle 100.

The frame 110 of the electric bicycle 100 has additional components including a rear triangle which comprises a chainstay 104, a seatstay 102 and the seat tube 118. Dropouts 106 are located between the chainstay 104 and the seatstay 102 and include slots which accept an axle of the rear wheel 125, allowing the rear wheel to be separated from the frame. In the case of a metal frame such as a steel, aluminum or titanium frame, the chainstay 104 and seatstay 102 comprise hollow tubes which are welded to the dropouts 106. The slot of the dropouts 106 is generally located in a solid portion of the dropouts. In some cases, the dropouts 106 may further comprise a tubular portion which interfaces with the tubes of the seatstay 102 and chainstay 104, e.g. through a butted interface. In other cases, the dropouts 106 may be entirely solid and welded or adhered to the seatstay 102 and chainstay 104.

The electric bicycle 100 also includes various other components, such as a front wheel 120 and rear wheel 125 that support the frame 110 of the electric bicycle 100, a crankset 140 that supports pedals 145, a chain 142 that extends from the crankset 140 to a rear axle of the rear wheel 125, and a rear rack 132 that supports cargo, passengers (and other accessories).

As depicted, a battery 160 is positioned and/or mounted to the down tube 114, where a controller (not shown) is internally mounted or disposed. Further, an electric motor 150 (e.g., a hub motor) is mounted to the rear wheel 125. During operation of the electric bicycle 100, the battery pack 160 provides power to the electric motor 150, which propels the electric bicycle under control of the controller.

A wiring harness 152 can facilitate the securement of cables 154 between components of the electric bicycle 100. For example, the wiring harness 152 can have a shape that conforms to the shape of the frame 110, such as the shape of the seat tube 118), in order to facilitate positioning of the harness next to and aligned with the frame 110, in order to securely contain cables that extend along one or more of the tubes between the electrical components.

In addition to the components depicted in FIG. 1, the electric bicycle 100 can include other components, such as brakes and braking systems, derailleurs, cassettes, various accessories, fenders, various types of rims, tires, or wheels, integrated locks or locking systems, lights and reflectors, bells or other audible alert systems, GPS, screens, and/or other user interfaces or display devices, and so on.

As described herein, the electric motor 150 can be a direct drive or hub motor, and be part of a regenerative braking operation, controlled by the controller, to generate energy provided to the battery 160.

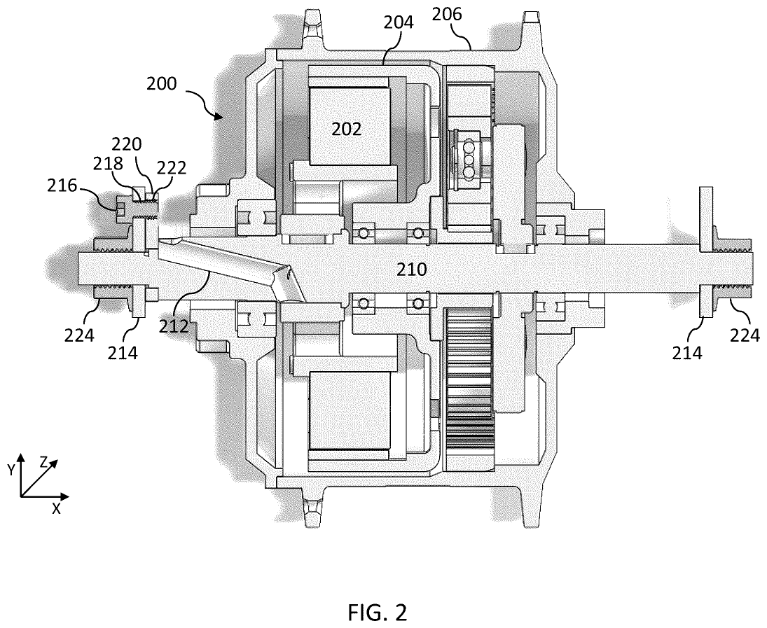

FIG. 2 is a diagram illustrating a motor 200 for an electric bicycle. The motor comprises a stator 202 and a rotor 204. The stator 202 comprises a set of copper windings and the rotor 204 comprises magnets such that when current is provided to the copper windings of the stator, the rotor rotates about the stator. The rotor 204 and the stator 202 are enclosed by a casing 206 which rotates along with the rotor 204. The casing 206 is coupled to the rear wheel 125 so that rotation of the casing 206 causes the bicycle 100 to move forward.

As seen in the figure, the axle 210 comprises a first exposed portion that extends out of a non-drive side of the casing 206 (on the left side of the figure) and a second exposed portion that extends out of a drive side of the casing 206 (on the right side of the figure). These exposed portions are exposed relative to the casing 206.

The stator 202 is statically coupled to an axle 210 that runs through a central axis of the motor 200. In operation, both the axle 210 and the stator 202 remain fixed while the rotor 204, the casing 206 and other components rotate around a central axis of the axle 210. A cable path 212 is located in the axle 210, and cabling (e.g. part of wiring harness 152) is routed into the motor 200 via the cable path 212. The axle 210 is clamped against dropouts 214 by respective nuts 224 threaded over threaded portions of the axle 210.

A torque plate 220 is coupled to the axle 210. In the embodiment shown in FIG. 2, the torque plate 220 is coupled to the axle 210 on a non-drive side of the motor 200. A second torque plate 220 may be present and coupled to a drive side of the axle 210 in a similar manner to the torque plate 220 on the non-drive side. In another embodiment, a torque plate 220 is only present on the drive side of motor 200. Accordingly, various embodiments may include one torque plate 220 on either the drive side or non-drive side of the motor 200, or torque plates 220 on both sides of the motor. A drive side of the motor 200 is a side of the motor that engages with external drive components, e.g. a freehub, gears or a chain, and a non-drive side of the motor may engage with braking components, for example.

The torque plate 220 shown in FIG. 2 is rigidly affixed to the first exposed portion of the axle 210. The torque plate 220 has a planar configuration aligned with a plane that is perpendicular to a central axis of the axle 210. With respect to FIG. 2, the torque plate 220 has a planar configuration aligned with a Y-Z plane, while the central axis of the axle 210 is in the X direction.

The torque plate 220 may be rigidly affixed to the axle 210 to effectively transfer tortional forces from the axle 210 to the frame 110 via dropouts 214. An example of rigid coupling between the torque plate 220 and the axle 210 is a press fit. In an embodiment, the torque plate 220 is pressed onto a drafted surface of the axle 210 so that the torque plate is semi-permanently attached to the axle. Other examples of a rigid coupling include welding and an adhesive bond, although other thermal, chemical and mechanical bonding techniques which provide an effective transfer of tortional forces between the axle 210 and torque plate 220 are possible.

The torque plate 220 in FIG. 2 is removably coupled to a dropout 214 by a bolt 216 which extends through a through hole 218 in the dropout and is threaded into a threaded through hole 222 in the torque plate. While this configuration provides access to the head of the bolt 216 from the exterior of the bicycle, the threads may alternatively be present in the through hole 218 in the dropout. In other embodiments, a removable pin or a protrusion may provide removable coupling between the dropout 214 and the torque plate 222 in addition to or alternative to the bolt 216.

The attachment configuration of FIG. 2 can prevent the axle 210 from twisting or reduce the amount of twist of the axle when it experiences tortional forces and transfers torque from the axle 210 to the dropout 214. The bolt 216 prevents the torque plate 220 from twisting by arresting rotation around the central axis of the axle 210.

The torque plate 220 may comprise a metal material such as steel, aluminum, titanium, etc. In some embodiments, the torque plate 220 may comprise a composite material such as a fiber reinforced polymer material, e.g. a carbon fiber composite. At least the exposed portions of a torque plate 220 may be painted, anodized, dip coated, or otherwise covered with a surface material that provides resistance to the elements and aesthetic qualities. In some embodiments, one or more physical interface between torque plate 220 and the axle 210 is uncoated, and other surfaces are coated. In an embodiment, the torque plate 220 is fitted over the axle 210 and both components are painted at the same time. In some embodiments, the torque plate 220 may have a thickness within a range of about 3 to 10 mm, a width within a range of about 10 to 40 mm, and a height within a range of about 25 to 60 mm. These ranges include the values at each end of the range. For example, the thickness range of about 3 to 10 mm includes thicknesses of about 3 mm and about 10 mm. The term “about” encompasses dimensions within engineering tolerances, e.g. plus or minus 5% of the target dimensions.

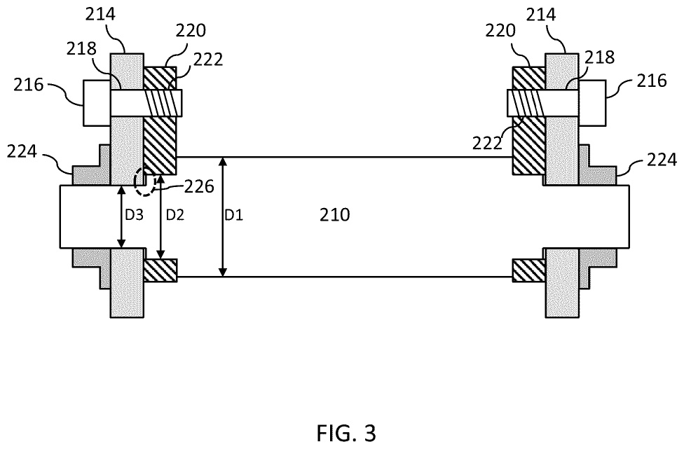

FIG. 3 is a simplified cross-section showing features that may be present in a motor 200 that is installed in a bicycle 100. In the example of FIG. 3, two torque plates 220 are coupled to the axle 210.

The axle 210 has a first thickness D1, a first shoulder that transitions to a second thickness D2 that is less than the thickness D1, and a second shoulder that transitions to a third thickness D3 that is less than the second thickness D2. Torque plates 220 are pressed against the first shoulder and have an opening that corresponds to the second thickness D2.

In the embodiment of FIG. 3, the torque plate 220 is slightly wider than the horizontal section between the first shoulder and second shoulder, creating a gap 226 between the vertical flat of the second shoulder and the dropouts 214. When such a gap 226 is present, a torque plate 220 presses against the inner side of the dropout 214. This configuration has potential advantages of ensuring that the torque plate 220 is held in place against the axle 210 and providing a larger frictional interface between the torque plate 220 and the dropout 214 than would be present between the axle 210 and the dropout 214. In an example, gap 226 is about 1 mm.

As shown, the torque plate 220 may overhang past the axle 210 providing gap 226 which provides contact pressure from a dropout 214 to the torque plate 220 and not the axle 210. Thus, the torque plate 220, having a certain geometry and being fixed to the axle 210, can assist and/or provide friction contacts at points that are away from an axis of rotation of the axle 210, which can enhance the ability for the torque plate 220 to transfer torque from the axle 210 to the dropout 214, via friction between the torque plate 220 and the dropout 214, given that frictional forces at a distance farther away from the axis of rotation provide more torque than the same force at a distance closer to the axis of rotation.

Further, a flange nut (e.g., an M12 flange nut) 224 can maintain the axle 210 in tension, supporting normal loads applied to the axle 210 during operation of the bicycle 100 and ensuring that the torque plate 220 is compressed against the frame 110.

As seen in FIG. 3, a second torque plate 220 may be fixed to the axle 210 on a drive side of the motor 200. The second torque plate 220 can provide additional torque support for the axle 210, and may be removable when other components (e.g., freewheel/cassette/cog) are to be removed. One or more washers can also be utilized to support the axle 220. Accordingly, a first torque plate 220 may be permanently or semi-permanently fixed to the axle 210, and a second torque plate 220 may be removably coupled to the axle 210, e.g. by threading or a friction fit.

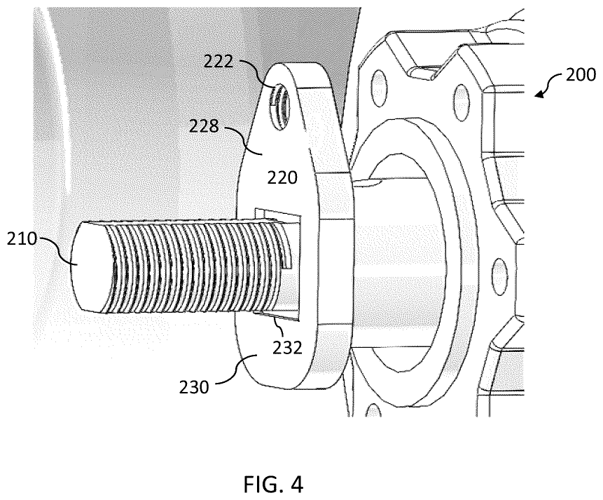

FIG. 4 illustrates an embodiment of a torque plate 220 coupled to an axle 210. In the embodiment of FIG. 4, the torque plate 220 comprises two lobes: a first lobe 228 that extends upwards with respect to a vertical orientation of the bicycle 100, and a second lobe 230 that extends downwards. In another embodiment, the first lobe 228 may be oriented in a horizontal direction, e.g. a chainstay direction. The first lobe 228 has a greater length than the second lobe 230. The first lobe (or upper lobe) 228 narrows as it extends upwards to create a rounded triangular shape, and through hole 222 is located within the triangular portion of the first lobe 228.

In some embodiments, the torque plate 220 may be sized such that a disc brake rotor can be removed or installed while the torque plate 225 is installed on the axle 210, while maximizing dimensions of the torque plate 220 to provide maximum torque transfer from the axle 210 to the frame 110. The precise shape and size of a torque plate 220 may be determined in consideration of the surrounding components, access and removability of components, rigidity, and weight. The asymmetric triangular upper lobe 228 represents one such shape, but other shapes are possible.

Before assembly, the torque plate 220 may be a separate component with an opening 232 that is pressed onto the axle 210. The opening 232 may have a circular shape that is pressed onto a corresponding circular outer diameter of the axle 210. In another embodiment, as seen in FIG. 4, the opening 232 may have one or more flat surface that aligns with a corresponding flat surface of the axle 210 (e.g., a 10 mm flat).

The presence of one or more flat surface on the axle 210 and one or more corresponding flat surface of the opening 232 of the torque plate 220 can provide an accurate and repeatable orientation of the torque plate 220 with respect to the axle 210, which can ensure that the through hole 222 of the torque plate 220 is aligned with the corresponding through hole 218 of the dropout 214. Another potential advantage of flats is the ability of the flat surfaces to effectively transfer torque from the axle 210 to the torque plate 220 without slipping or twisting.

Flat surfaces may be present at a portion of the axle 210 corresponding to the second thickness D2 of FIG. 3 and/or at the end of an axle corresponding to the third thickness D3, and as shown at the threaded ends of the axle 210 in FIG. 4. Flats at the threaded ends of the axle 210 may provide a larger contact surface between a slot in the dropouts 214 and the axle 210, and may allow the slot of the dropouts 214 to resist tortional forces of the axle 210 along with the torque plate 220.

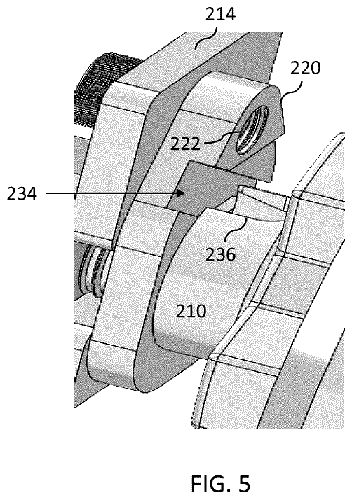

FIG. 5 illustrates an embodiment of a torque plate 220 which comprises a slot 234 for cable routing. In some embodiments, cables are routed into the non-drive side of the axle 210 at an exposed portion of the axle between the casing 206 and the dropouts 214. When a torque plate 220 is present on the non-drive side of the axle 210, the torque plate 220 occupies part of the space between the motor casing 206 and the dropout 214, which can make it difficult to route cables into the axle 210. The slot 234 addresses this potential issue by providing additional clearance at the cable insertion point (opening 236).

The slot 234 in the torque plate 220 is aligned with and overlaps with opening 236 in the axle 210, which is an opening to the cable path 212 illustrated in FIG. 2. The slot 234 may have a diagonal orientation with respect to the opening 236 and the through hole 222 so that cabling (not shown) for the motor 200 can be routed between the through hole 222 and the opening 236 of the axle. In the embodiment of FIG. 5, the through hole 222 and the opening 236 of the axle are oriented in the same direction with respect to an axis of the axle 210, and the slot 234 is angled relative to that direction.

A high side of the diagonal slot 234 may be oriented with the direction from which the cabling approaches the axle 210, e.g. a forward direction, and mid-point of the diagonal slot 234 may be aligned with the opening 236. The slot 234 may extend across the full width of the torque plate 234 to provide sufficient space and for ease of manufacturing. The one or more flat surface of axle 210 described above may assist with proper alignment between the slot 234 and the opening 236.

Thus, in various embodiments, a torque plate 220 is fixed to an axle 210 of an electric bicycle 210, which facilitates directing forces experienced by the axle 210 during regenerative braking or normal forward acceleration performed by a direct drive hub motor 200 away from the axle flange nuts 224 and to a frame 110 or other similar components of the electric bicycle. In the present disclosure, even though one or more torque plate 220 may be removable from the motor 200, it is still considered part of the motor.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or”, in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the electric bike and bike frame may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

From the foregoing, it will be appreciated that specific embodiments have been described herein for purposes of illustration, but that various modifications may be made without deviating from the spirit and scope of the embodiments. Accordingly, the embodiments are not limited except as by the appended claims.

What is claimed is:

1. An electric motor for an electric vehicle, the electric motor comprising:
a stator;
a rotor configured to rotate around the stator;
a casing enclosing the stator and the rotor;
an axle coupled to the stator, the axle comprising a first exposed portion that extends out of a non-drive side of the casing and a second exposed portion that extends out of a drive side of the casing; and
a torque plate rigidly affixed to the first exposed portion of the axle, the torque plate having a planar configuration aligned with a plane that is perpendicular to a central axis of the axle.

2. The electric motor of claim 1, wherein the axle comprises a flat surface on the first exposed portion, and the torque plate comprises an opening with a flat surface in contact with the flat surface of the axle.

3. The electric motor of claim 1, further comprising:
a second torque plate removably coupled to the second exposed portion of the axle.

4. The electric motor of claim 1, wherein the axle comprises a cable opening that leads to a cable path inside the axle, and the torque plate comprises a slot that provides a route to the cable opening in the axle.

5. The electric motor of claim 1, wherein the torque plate is rigidly affixed to the axle by at least one of a press fit, a weld, and an adhesive bond.

6. The electric motor of claim 1, wherein the axle has a first thickness, a second thickness that is less than the first thickness, and a shoulder between the first thickness and the second thickness, and
wherein the torque plate is pressed against the shoulder between the first and the second thickness.

7. The electric motor of claim 6, wherein the axle has a third thickness adjacent to the second thickness and less than the second thickness, and
wherein a portion of the torque plate extends over the third thickness of the axle.

8. The electric motor of claim 1, wherein the torque plate has an asymmetric shape, and comprises a through hole configured to engage with a vehicle frame is in a lobe of the asymmetric shape.

9. The electric motor of claim 1, wherein the torque plate has a thickness within a range of about 3 to 10 mm, a width within a range of about 10 to 40 mm, and a height within a range of about 25 to 60 mm.

10. An electric bicycle comprising:
a frame;
a battery; and
a motor coupled to the battery, the motor comprising:
a stator;
a rotor configured to rotate around the stator;
a casing enclosing the stator and the rotor;
an axle coupled to the stator, the axle comprising a first exposed portion that extends out of a non-drive side of the casing and a second exposed portion that extends out of a drive side of the casing; and
a torque plate rigidly affixed to the first exposed portion of the axle, the torque plate having a planar configuration aligned with a plane that is perpendicular to a central axis of the axle.

11. The electric bicycle of claim 10, wherein the axle comprises a flat surface on the first exposed portion, and the torque plate comprises an opening with a flat surface in contact with the flat surface of the axle.

12. The electric bicycle of claim 10, further comprising:
a second torque plate removably coupled to the second exposed portion of the axle.

13. The electric bicycle of claim 10, wherein the axle comprises a cable opening that leads to a cable path inside the axle, and the torque plate comprises a slot which provides a route to the cable opening in the axle.

14. The electric bicycle of claim 10, wherein the torque plate is rigidly affixed to the axle by at least one of a press fit, a weld and an adhesive bond.

15. The electric bicycle of claim 10, wherein the axle has first thickness, a second thickness that is less than the first thickness, and a shoulder between the first thickness and the second thickness, and
wherein the torque plate is pressed against the shoulder between first and second thickness.

16. The electric bicycle of claim 15, wherein the axle has a third thickness adjacent to the second thickness and less than the second thickness, and
wherein a portion of the torque plate extends over the third thickness of the axle.

17. The electric bicycle of claim 15, wherein the torque plate is in contact with a dropout of the frame and a gap is present between a portion of the axle with the second thickness and the dropout of the frame.

18. The electric bicycle of claim 10, wherein the torque plate has an asymmetric shape, and comprises a through hole configured to engage with the frame is in a lobe of the asymmetric shape.

19. The electric bicycle of claim 10, wherein the electric bicycle is configured for regenerative braking.

20. The electric bicycle of claim 10, wherein the torque plate is removably coupled to a dropout of the frame and configured to transfer torque from the axle to the frame.
